(19) United States
(12) Patent Application Publication
(10) Pub. No.: US 2021/0106189 A1
(43) Pub. Date: Apr. 15, 2021

(54) Peecasso

(71) Applicant: Stephanie Ann Green, Milwaukie, OR (US)

(72) Inventor: Stephanie Ann Green, Milwaukie, OR (US)

(21) Appl. No.: 16/598,301

(22) Filed: Oct. 10, 2019

(51) Int. Cl. A47K 11/04; G09B 19/00

(52) U.S. Cl. CPC A47K 11/04; G09B 19/0076

(57) ABSTRACT

The purpose of this patent application is to obtain a patent on the Peecasso, a potty-training tool for girls. The main purpose for this invention is to benefit caretakers in terms of helping to potty-train girls and making girls want to use the toilet instead of wear diapers. This potty-training tool will entice girls to use the toilet as they want to see the painting light up. The more they pee on it, the more the picture lights up.

### CROSS-REFERENCE TO RELATED APPLICATIONS

This section is non-applicable to this patent application.

### STATEMENT REGARDING FEDERALLY SPONSORED RESEARCH OR DEVELOPMENT (IF APPLICABLE)

There are no rights to this invention under federally sponsored research and development programs.

### REFERENCE TO SEQUENCE LISTING, A TABLE, OR A COMPUTER PROGRAM LISTING COMPACT DISC APPENDIX

This section is non-applicable to this patent application.

### BACKGROUND OF THE INVENTION

This is a new invention in which no patents or ideas already exist. This is a brand-new product that will be brought to the market. This invention does not improve any other product on the market. It is a new product and that is standalone. The main impetus for the Peecasso is to help young girls potty train. There are so many boy potty training products on the market and the girl potty training toys and tools are lacking. This potty-training tool for girls mounts on the toilet and they pee onto what looks to be a painting and when the urine hits the painting, colors light up, The color effect is due to the thermochromic paint pigment that is used on the pseudo painting that girls pee on. Upon a heat source, which is urine, the plastic changes colors and through this process a picture is revealed. All pictures and designs are in scope of this patent.

Stephanie Ann Green is a full-time working mother of 3 small kids with an MBA. One of her true passions in life is spending time raising her 3 kids. One major challenge for all her kids is how to get them interested in potty training. There is such a lack of potty-training tools and toys for girls on the market. Nothing cool to capture their interest. Therefore, with this need in mind, Stephanie Green created the Peecasso.

### BRIEF SUMMARY OF THE INVENTION

As mentioned above, there is a huge market and need for this product. The invention is comprised of a plastic blank canvas for painting that is clipped onto the toilet and the girl sits on the toilet to go potty, and pees onto the plastic canvas and as the urine hits it, the painting starts to change colors upon a heat source (urine) and a picture is revealed.

### BRIEF DESCRIPTION OF THE SEVERAL VIEWS OF THE DRAWING

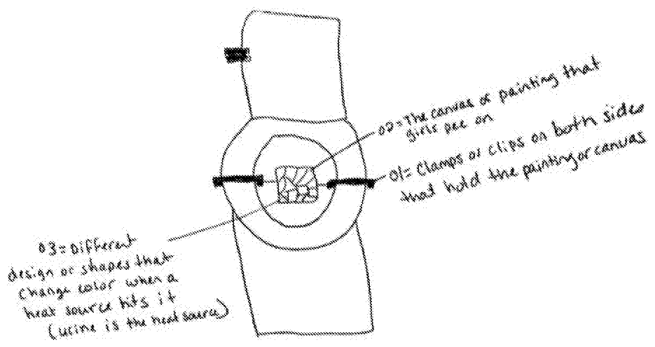

Please refer to the separate diagram of the Peecasso FIG. 1. Each element is properly labeled.

### DETAILED DESCRIPTION OF THE INVENTION

There is no other invention like this one the market. The process is simple with existing materials on the market. All materials are on the market currently so it's a matter of assembling existing materials that are commercially available. The main details of the invention are plastic clips that are assembled to hold a plastic canvas over the center of the toilet bowl (below the lid) and the plastic canvas is made out of thermochromic paint pigment. The canvas looks blank until a heat source, which is urine, hits it and lights up the picture due to the thermochromic paint pigment that is on the canvas.

Thermochromic paint pigment is commercially available and the canvas will be painted with thermochromic paint pigment. Thermochromic paint pigment changes colors upon a heat source. The heat source is urine.

1. A potty-training tool for girls that clips on the toilet seat and contains something that looks like a painting canvas that girls pee on, and when the pee hits the canvas it changes colors.
(a) A potty-training canvas looking tool that mounts onto a toilet seat that changes color due to a heat source (urine is the heat source).
(b) A plastic looking painting that sits on the toilet by clamps/clips and is painted with thermochromic paint pigment that changes color when a heat source (urine) hits it.
(c) All designs and patterns are in scope with regard to the design of the painting.
